(19) United States
(12) Patent Application Publication
(10) Pub. No.: US 2011/0008712 A1
(43) Pub. Date: Jan. 13, 2011

(54) Fuel Cell Having Single Body Support

(76) Inventors: Kyong Bok MIN, Gyunggi-do (KR); Jae Hyuk Jang, Gyunggi-do (KR); Hong Ryul Lee, Gyunggi-do (KR); Jae Hyoung Gil, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/550,118

(22) Filed: Aug. 28, 2009

(30) Foreign Application Priority Data
Jul. 13, 2009 (KR) 10-2009-0063657

(51) Int. Cl. H01M 2/02

(52) U.S. Cl. 429/508

(57) ABSTRACT

Disclosed is a fuel cell having a single body support, which includes a single body support including a plurality of unit supports and a connector for connecting the plurality of unit supports in parallel, an air electrode layer formed on an outer surface of the single body support, an electrolyte layer formed on an outer surface of the air electrode layer, and a fuel electrode layer formed on an outer surface of the electrolyte layer, so that the fuel cell is stably supported thus increasing durability and reliability.

### CROSS REFERENCE TO RELATED APPLICATION

This application claims the benefit of Korean Patent Application No. 10-2009-0063657, filed Jul. 13, 2009, entitled “Fuel cell having single body support”, which is hereby incorporated by reference in its entirety into this application.

### BACKGROUND OF THE INVENTION

1. Technical Field

The present invention relates to a fuel cell having a single body support.

2. Description of the Related Art

A fuel cell is a device for directly converting the chemical energy of a fuel (hydrogen, LNG, LPT, etc.) and air into electric power and heat using an electrochemical reaction. Unlike conventional techniques for generating power including combustion of fuel, generation of steam, operation of a turbine and operation of a power generator, the fuel cell has neither a combustion procedure nor an operator and is thus regarded as a novel power generation technique which results in high cell performance and no environmental problems.

FIG. 1 shows the principle behind the operation of a fuel cell.

With reference to FIG. 1, hydrogen (H₂) is supplied to a fuel electrode 1 and is then decomposed into protons (H⁺) and electrons (e⁻). The protons are transferred to an air electrode 3 via an electrolyte 2. The electrons pass through an external circuit 4 causing current to flow. In the air electrode 3, the protons and the electrons are combined with oxygen in the air, thus producing water. The chemical reaction of the fuel cell 10 is represented by Reaction 1 below.

Fuel Electrode: H₂→2H⁺+2e⁻ Air Electrode: ½O2+2H⁺+2e^{-→H}₂O Total Reaction: H₂+½O2→H₂O Reaction 1

Specifically, the fuel cell performs a cell function by passing the electrons separated in the fuel electrode I through the external circuit so that current is produced. Such a fuel cell 10 rarely discharges air pollutants such as SOx and NOx and generates a small amount of carbon dioxide and is thus a pollution-free power generator, and is also advantageous in terms of being low noise and without vibrations.

Examples of fuel cells include a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and so on. In particular, SOFC enables high-efficiency power generation and composite power generation of coal gas-fuel cell-gas turbine and is variable in power generation capacity and is thus suitable for use in small and large power plants or as a distributed power source. Hence, the SOFC is essential for realizing a hydrogen-based society in the future.

However, actual use of the SOFC incurs the following problems which need to be solved.

First, the SOFC has poor durability and reliability. Because the SOFC is operated at high temperature, its performance is reduced due to a heat cycle. In particular, in the case where the fuel electrode or the air electrode is used as a support for other elements, when the size of the cell is increased, durability and reliability of parts thereof may be drastically deteriorated due to properties of ceramic used.

Second, the SOFC makes it difficult to collect current. According to conventional techniques, current is collected by using metal foam inside the unit cell and metal wires outside the unit cell. However, in such a structure, as the size of the cell is increased, the amount of expensive metal wires is increased, undesirably increasing the manufacturing cost and causing a complicated structure, thus making it difficult to realize mass production.

Third, the SOFC makes it difficult to connect the unit cell to a manifold. The manifold for supplying fuel such as hydrogen to the unit cell is made mainly of metal, whereas the unit cell is made of ceramic. Thus, in order to connect the metal and the ceramic which are different from each other, a brazing process is used. However, the brazing process is disadvantageous because the unit cell may be clogged or it may be welded poorly, as this is dependent on the speed of increasing the voltage of the inductive coil in the welding procedure, the time that the voltage is maintained, and the cooling conditions following the brazing process.

Fourth, the SOFC is difficult to mold. According to conventional techniques, a ceramic molded body having a predetermined diameter is produced through a typical extrusion process. However, the mixing paste used for the extrusion process contains 15˜20% water and thus should be very carefully dried for a long period of time. When the drying process is performed for a short period of time, internal stress occurs and thus the ceramic molded body may crack. Also, it is difficult to vary the shape of the produced ceramic molded body.

Fifth, in the case of a multi-cell type SOFC, a cell stack should be formed from a plurality of unit cells which are aligned. However, the formation of the stack requires complicated connections between current collectors and the respective unit cells. Furthermore, as the number of unit cells is increased, current collection resistance is increased, undesirably reducing cell performance.

### SUMMARY OF THE INVENTION

Accordingly, the present invention has been made keeping in mind the problems encountered in the related art and the present invention intends to provide a fuel cell having a single body support, which facilitates the collection of current, is easily molded and may reduce the manufacturing process and the manufacturing cost.

A first aspect of the present invention provides a fuel cell including a single body support including a plurality of unit supports and a connector for connecting the plurality of unit supports in parallel, an air electrode layer formed on an outer surface of the single body support, an electrolyte layer formed on an outer surface of the air electrode layer, and a fuel electrode layer formed on an outer surface of the electrolyte layer.

In the first aspect, the air electrode layer may be formed only on an outer surface of the unit supports.

In the first aspect, the connector may be formed to be shorter than the unit supports.

In the first aspect, the connector may have a gas passage passing therethrough to be perpendicular thereto.

In the first aspect, the unit supports may have a cross-section of a circular shape, a flat tubular shape, a delta shape or a trapezoidal shape.

In the first aspect, the single body support may be made of porous metal.

As such, the porous metal may be selected from the group consisting of iron, copper, aluminum, nickel, chromium, alloys thereof and combinations thereof.

A second aspect of the present invention provides a fuel cell including a single body support including a plurality of unit supports and a connector for connecting the plurality of unit supports in parallel, a fuel electrode layer formed on an outer surface of the single body support, an electrolyte layer formed on an outer surface of the fuel electrode layer, and an air electrode layer formed on an outer surface of the electrolyte layer.

In the second aspect, the fuel electrode layer may be formed only on an outer surface of the unit supports.

In the second aspect, the connector may be formed to be shorter than the unit supports.

In the second aspect, the connector may have a gas passage passing therethrough to be perpendicular thereto.

In the second aspect, the unit supports may have a cross-section of a circular shape, a flat tubular shape, a delta shape or a trapezoidal shape.

In the second aspect, the single body support may be made of a porous metal.

As such, the porous metal may be selected from the group consisting of iron, copper, aluminum, nickel, chromium, alloys thereof and combinations thereof.

### BRIEF DESCRIPTION OF THE DRAWINGS

The features and advantages of the present invention will be more clearly understood from the following detailed description taken in conjunction with the accompanying drawings, in which:

FIG. 1 is a view showing the operating principle behind a fuel cell;

FIG. 2 is a cross-sectional view showing a fuel cell according to a first embodiment of the present invention;

FIG. 3 is a cross-sectional view showing the fuel cell in which an air electrode layer is formed only on an outer surface of unit supports, according to the first embodiment of the present invention;

FIG. 4 is a perspective view showing the fuel cell in which connectors are formed to be shorter than the unit supports, according to the first embodiment of the present invention;

FIG. 5 is a perspective view showing the fuel cell in which gas passages are formed in the connectors, according to the first embodiment of the present invention;

FIGS. 6A to 6D are cross-sectional views showing the fuel cell in which the unit supports have various cross-sectional shapes, according to the first embodiment;

FIG. 7 is a cross-sectional view showing a fuel cell according to a second embodiment of the present invention;

FIG. 8 is a cross-sectional view showing the fuel cell in which a fuel electrode layer is formed only on an outer surface of unit supports, according to the second embodiment of the present invention;

FIG. 9 is a perspective view showing the fuel cell in which connectors are formed to be shorter than the unit supports, according to the second embodiment of the present invention;

FIG. 10 is a perspective view showing the fuel cell in which gas passages are formed in the connectors, according to the second embodiment of the present invention; and

FIGS. 11A to 11D are cross-sectional views showing the fuel cell in which the unit supports have various cross-sectional shapes, according to the second embodiment.

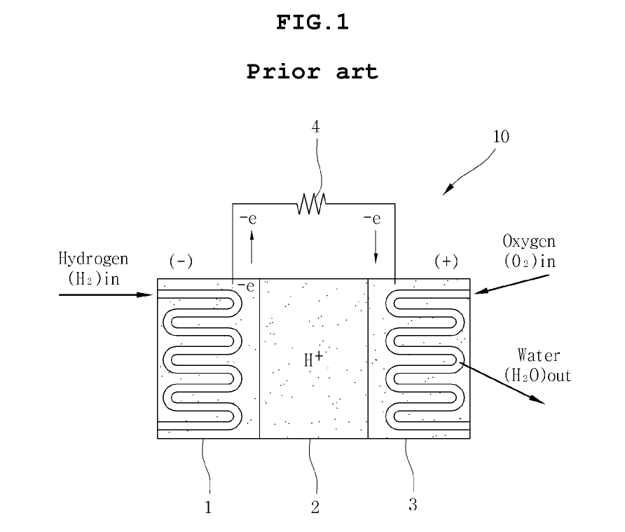

### DESCRIPTION OF SPECIFIC EMBODIMENTS

Hereinafter, a detailed description will be given of embodiments of the present invention with reference to the accompanying drawings. Throughout the drawings, the same reference numerals refer to the same or similar elements, and redundant descriptions are omitted. Also in the drawings, O₂ and H₂ are merely illustrative to specify the operative procedure of a fuel cell but the type of gas supplied to a fuel electrode or an oxygen electrode is not restricted. In the description, in the case where known techniques pertaining to the present invention are regarded as unnecessary because they make the characteristics of the invention unclear and also for the sake of description, the detailed descriptions thereof may be omitted.

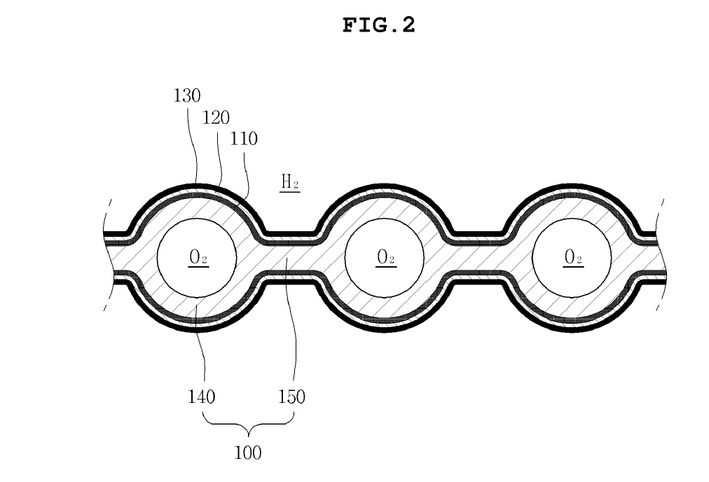

FIG. 2 is a cross-sectional view showing a fuel cell having a single body support according to a first embodiment of the present invention. Below, the fuel cell according to the present embodiment is described with reference to the above drawing.

As shown in FIG. 2, the fuel cell according to the present embodiment includes a single body support 100 having a plurality of unit supports 140 and connectors 150 for connecting the plurality of unit supports 140 in parallel, an air electrode layer 110 formed on an outer surface of the single body support 100, an electrolyte layer 120 formed on an outer surface of the air electrode layer 110, and a fuel electrode layer 130 formed on an outer surface of the electrolyte layer 120.

The single body support 100 functions to support a plurality of unit cells parallel to each other. Because the plurality of unit cells is supported by one support, the cell structure is stable and the cell stack is easily manufactured. Also, the single body support 100 includes the unit supports 140 for supporting respective unit cells and the connectors 150 for connecting the unit supports 140 in parallel. As such, the unit supports 140 and the connectors 150 may be simultaneously produced through an extrusion process, thus completing the single body support 100. Alternatively, the unit supports 140 and the connectors 150 may be separately formed and then connected to each other, thus completing the single body support 100. These methods are merely illustrative, and other methods may be used as long as the final shape of the resultant support is the same as that of the single body support 100, which should also fall within the scope of the present invention.

In order to produce current, air should be transferred to the air electrode layer 110. In the fuel cell according to the present embodiment, the single body support 100 receives air from a metal manifold and then transfers air to the air electrode layer 110. Thus, the single body support 100 may be made of porous metal which is gas permeable and is easily connected to the metal manifold. The porous metal may include metal foam, plate or metal fiber. In consideration of performance and strength of the fuel cell, the porous metal is selected from the group consisting of iron, copper, aluminum, nickel, chromium, alloys thereof and combinations thereof.

The single body support 100 made of porous metal is conductive, and thus current collection is possible using only the single body support 100 without an additional current collector. For example, without the need to provide the current collector in respective unit cells as in conventional techniques, when an external circuit is connected to one end of the single body support 100, current being generated from the air electrode layer 110 may be collected, thus obtaining high current collection efficiency.

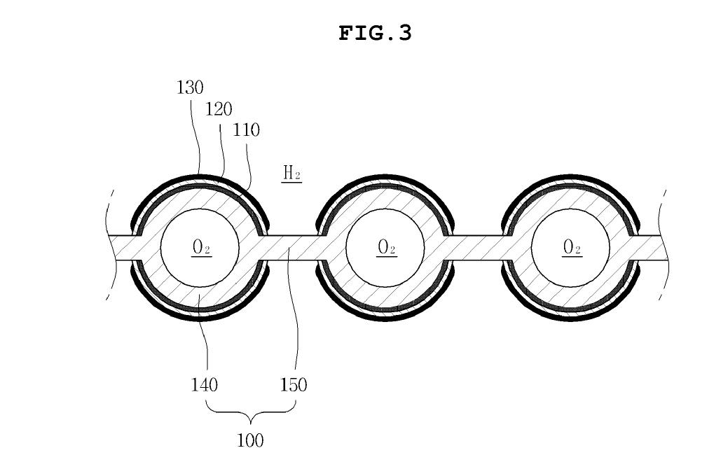

On the other hand, because it is difficult to supply air to the air electrode layer 110 formed on the connectors 150, no current is actually produced. Thus, as shown in FIG. 3, the air electrode layer 110 may be formed only on the unit supports 140 of the single body support 100. In this case, the connectors 150 are formed to pass through the air electrode layer 110, the electrolyte layer 120 and the fuel electrode layer 130. In order to prevent electrical conduction between the air electrode layer 110 and the fuel electrode layer 130 through the connectors, the fuel electrode layer 130 may be spaced apart from the connectors 150 by a predetermined interval, or an insulating layer (not shown) may be formed between the fuel electrode layer 130 and the connectors 150.

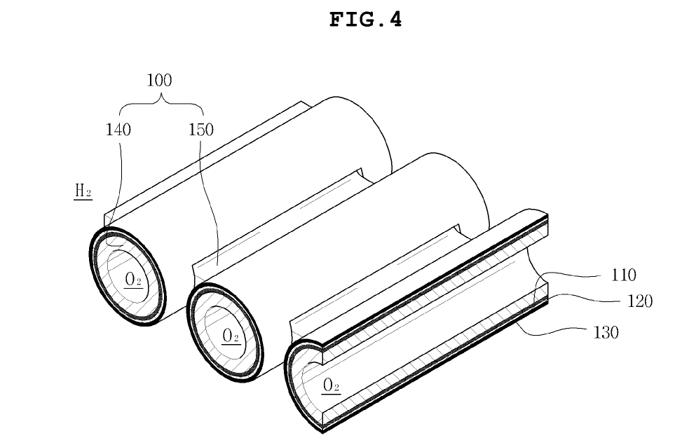

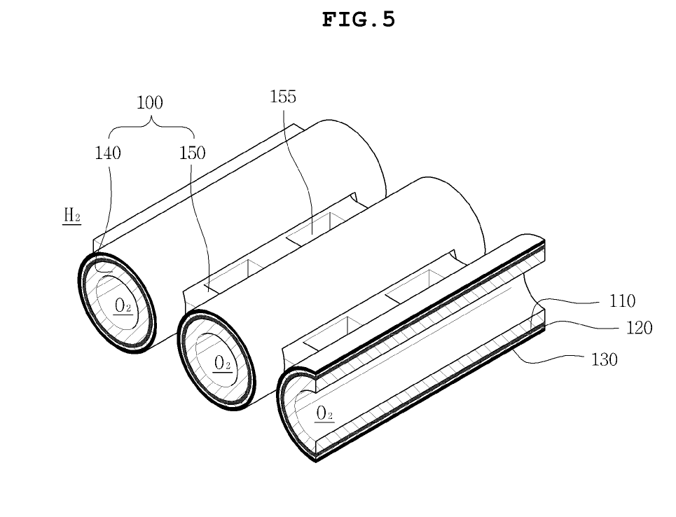

Furthermore, fuel should be supplied to the fuel electrode layer 130. In the fuel cell according to the present embodiment, because the fuel electrode layer 130 is formed at an outermost position, fuel is supplied from outside the fuel cell. In the case where the fuel cell according to the present invention is provided in the form of a multilayered stack, the connectors 150 of the single body support 100 may block the flow of fuel in a perpendicular direction and thus performance of the fuel cell may be deteriorated. For this reason, as shown in FIG. 4, the connectors 150 may be processed to be shorter than the unit supports 140, so that fuel efficiently flows in a perpendicular direction. The connectors 150 may be processed by simultaneously manufacturing the unit supports 140 and the connectors 150 through extrusion and then performing cutting, or by separately forming the connectors 150 to be shorter and then connecting them to the unit supports 140. Also, as shown in FIG. 5, gas passages 155 passing through the connectors 150 may be formed, thus facilitating the efficient flow of fuel. Such gas passages 155 may be formed through drilling or cutting.

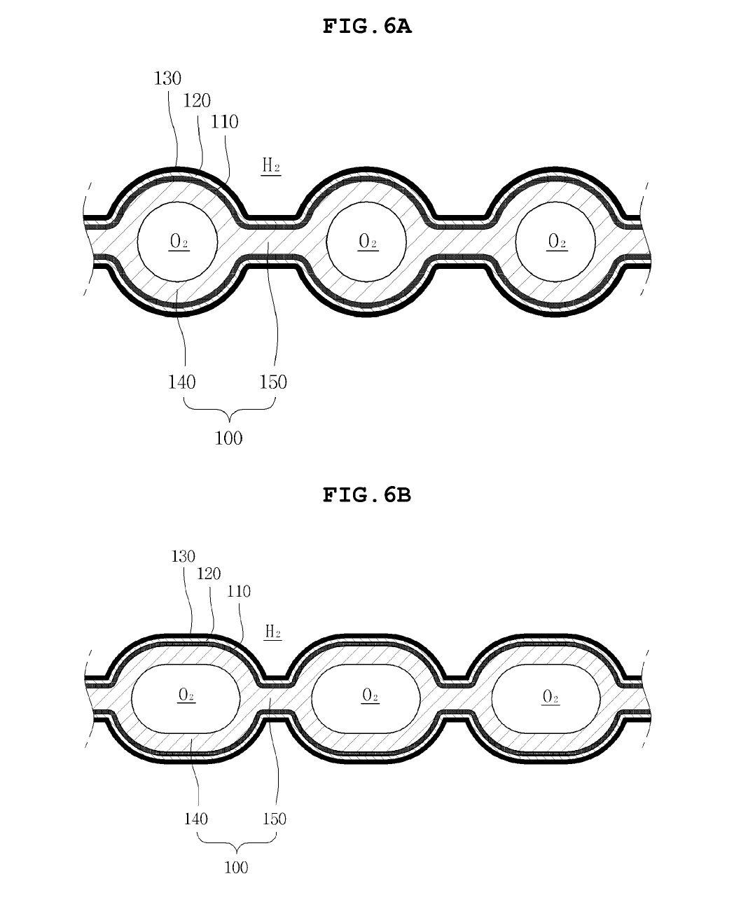

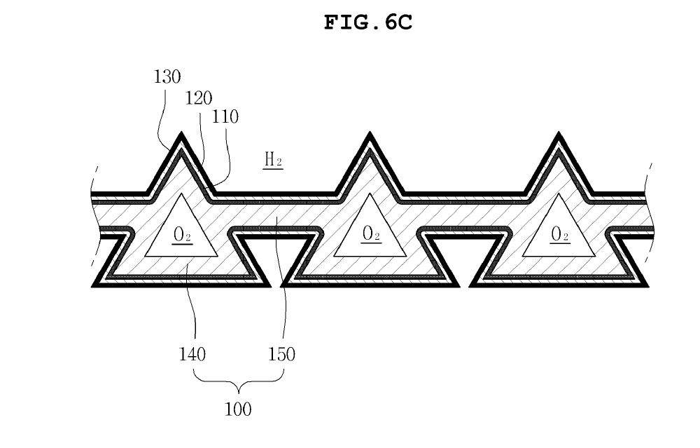

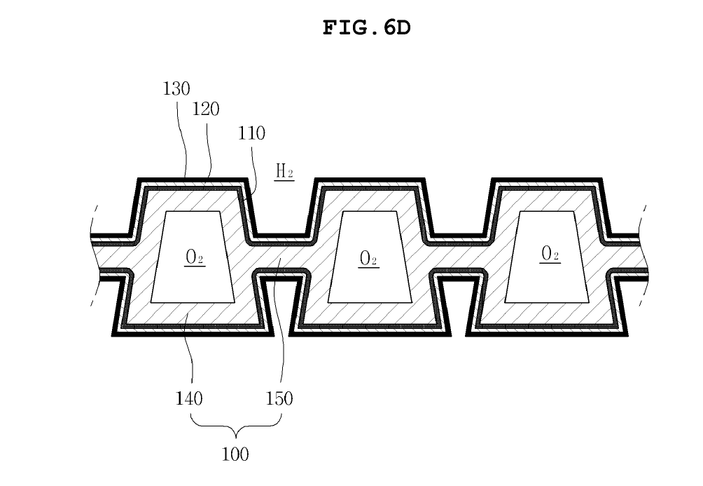

FIGS. 6A to 6D are cross-sectional views showing various cross-sectional shapes of the unit supports of the fuel cell. As shown in FIGS. 6A to 6D, the cross-sectional shape of the unit supports may have a circular shape (FIG. 6A), a flat tubular shape (FIG. 6B), a delta shape (FIG. 6C) or a trapezoidal shape (FIG. 6D). In particular, when the single body support 100 is formed of porous metal, it may be more easily molded compared to a conventional ceramic support. Thus, a fuel cell having any shape appropriate for its end use may be manufactured, and the size thereof may be increased, if needed.

The air electrode layer 110 is formed on the outer surface of the single body support 100. The single body support 100 is porous so that air permeates the single body support 100 and is then transferred to the air electrode layer 110. The single body support 100 is metal so that electrons generated from the fuel electrode layer 130 flow to the air electrode layer 110. The protons (when hydrogen is used as fuel) are transferred to the air electrode layer 110 from the electrolyte layer 120. Consequently, the air, the electrons and the protons are combined together in the air electrode layer 110, thus producing water. The air electrode layer 110 may be formed by applying LSM (Strontium doped Lanthanum Manganite) or LSCF ((La,Sr)(Co,Fe)O₃) through slip coating or plasma spray coating and then sintering it at 1200˜1300° C.

The electrolyte layer 120 is formed on the outer surface of the air electrode layer 110. The electrolyte layer 120 does not pass electrons therethrough, and transfers only the protons to the air electrode layer 110 upon use of hydrogen as fuel. The electrolyte layer 120 may be formed by applying YSZ (Yttria stabilized Zirconia) or ScSZ (Scandium stabilized Zirconia), GDC or LDC on the outer surface of the air electrode layer 110 through slip coating or plasma spray coating and then sintering it at 1300˜1500° C.

Also, the fuel electrode layer 130 is formed on the outer surface of the electrolyte layer 120. The fuel electrode layer 130 receives fuel from the outside thus generating electrons. The fuel electrode layer 130 may be formed by applying NiO—YSZ (Yttria stabilized Zirconia) on the outer surface of the electrolyte layer 120 through slip coating or plasma spray coating and then heating it to 1200˜1300° C.

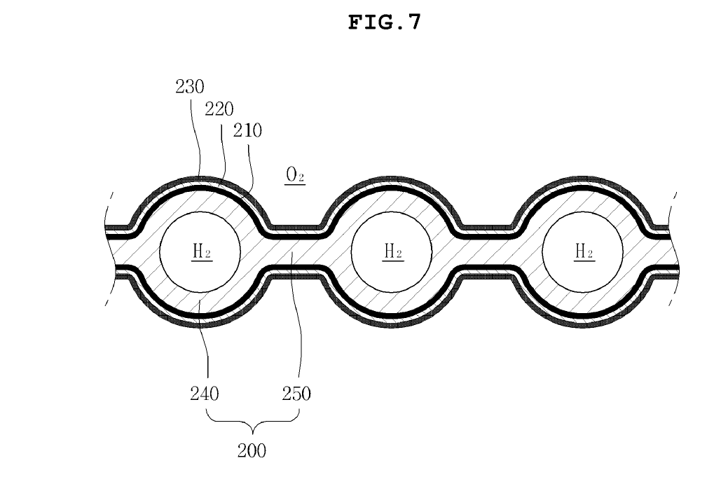

FIG. 7 is a cross-sectional view showing a fuel cell having a single body support according to a second embodiment of the present invention. The major difference between the present embodiment and the first embodiment is the position at which the fuel electrode layer and the air electrode layer are formed. Below, the description the same as that of the first embodiment is omitted, and portions of the description which are different are provided.

As shown in FIG. 7, the fuel cell according to the present embodiment includes a single body support 200 having a plurality of unit supports 240 and connectors 250 for connecting the plurality of unit supports 240 in parallel, and a fuel electrode layer 210 formed on an outer surface of the single body support 200, an electrolyte layer 220 formed on an outer surface of the fuel electrode layer 210, and an air electrode layer 230 formed on an outer surface of the electrolyte layer 220.

Fuel should be transferred to the fuel electrode layer 210 to produce current. In the fuel cell according to the present embodiment, the single body support 200 receives fuel from a metal manifold and then transfers such fuel to the fuel electrode layer 210. Thus, the single body support 200 may be formed of porous metal which is gas permeable and is easily connected to the metal manifold. As such, the porous metal includes metal foam, plate or metal fiber. In consideration of performance and strength of the fuel cell, the porous metal is selected from the group consisting of iron, copper, aluminum, nickel, chromium, alloys thereof and combinations thereof.

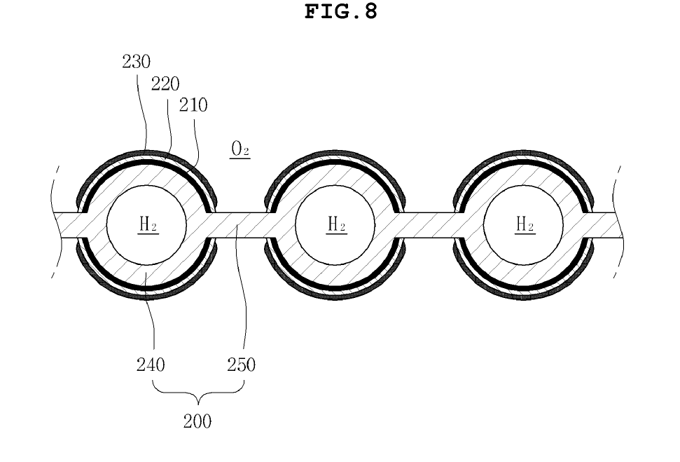

Because it is difficult to supply fuel to the fuel electrode layer 210 formed on the connectors 250, no current is actually caused. Thus, as shown in FIG. 8, the fuel electrode layer 210 may be formed only on the unit supports 240 of the single body support 200. In this case, the connectors 250 are formed to pass through the fuel electrode layer 210, the electrolyte layer 220 and the air electrode layer 230. In order to prevent electrical conduction between the air electrode layer 230 and the fuel electrode layer 210 through the connectors 250, the air electrode layer 230 may be spaced apart from the connectors 250 by a predetermined interval, or an insulating layer (not shown) may be formed between the air electrode layer 230 and the connectors 250.

As mentioned above, the single body support 200 made of porous metal is conductive, and thus current collection is possible using only the single body support 200 without an additional current collector.

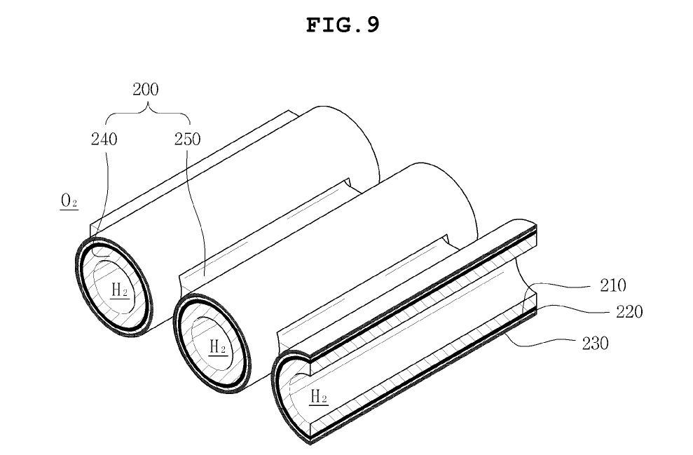

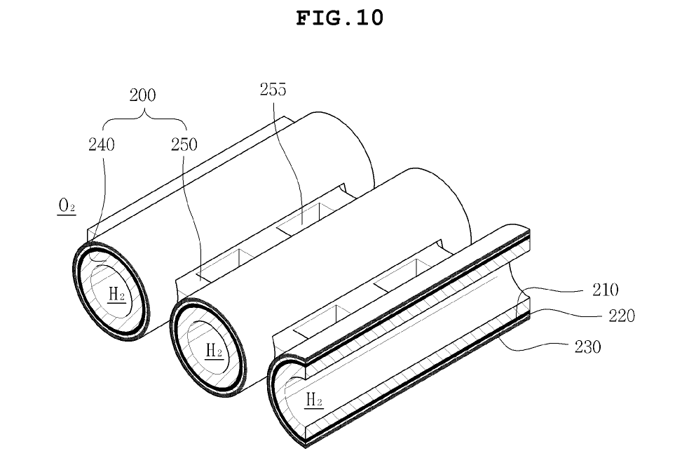

Furthermore, air should be supplied to the air electrode layer 230. In the fuel cell according to the present embodiment, because the air electrode layer 230 is formed at an outermost position, air is supplied from outside the fuel cell. In the case where the fuel cell having the single body support 200 is provided in the form of a multilayered stack, the connectors 250 of the single body support 200 may block the flow of air in a perpendicular direction, and thus performance of the fuel cell may be deteriorated. Hence, as shown in FIG. 9, the connectors 250 may be processed to be shorter than the unit supports 240, so that air efficiently flows in a perpendicular direction. As shown in FIG. 10, gas passages 255 passing through the connectors 250 may also be formed, thus facilitating the efficient flow of air.

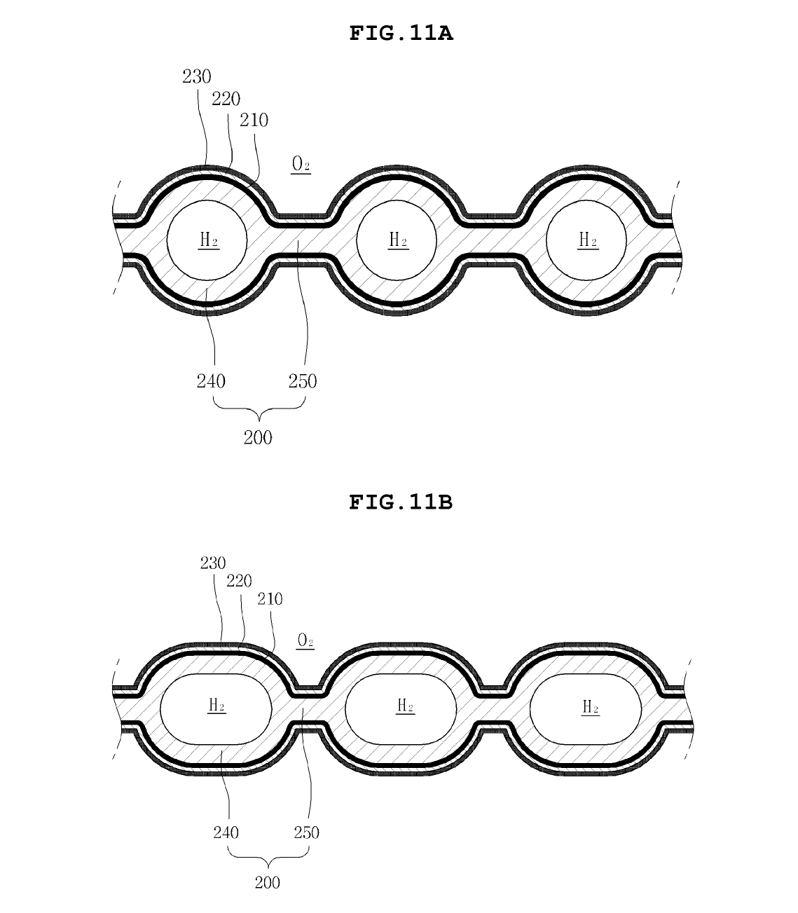

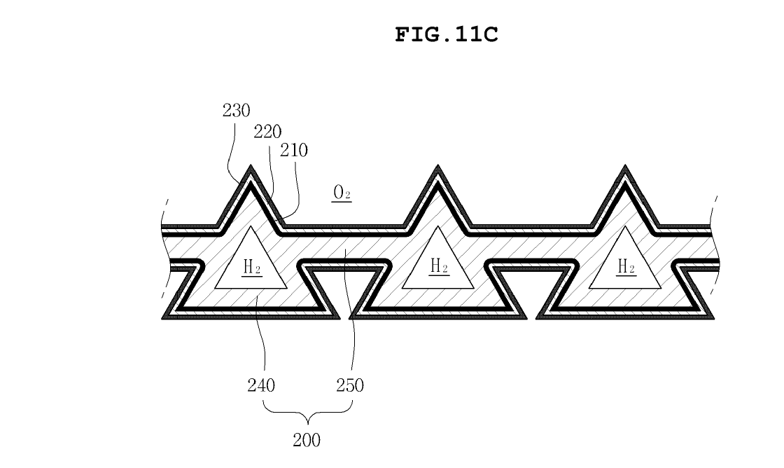

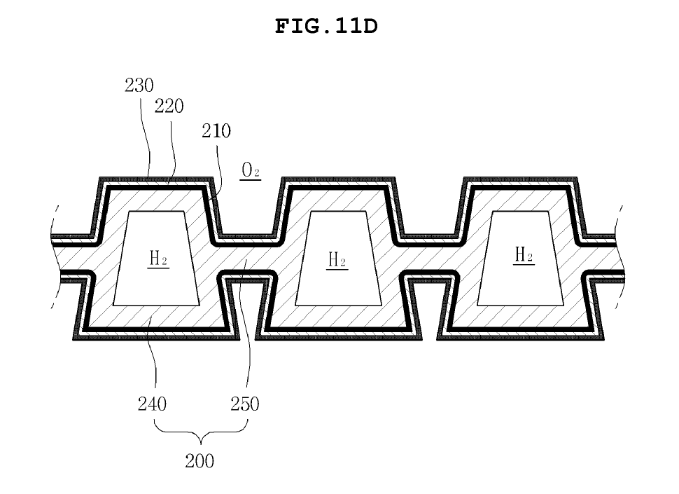

As shown in FIGS. 11A to 11D, the cross-sectional shape of the unit supports may have a circular shape (FIG. 11A), a flat tubular shape (FIG. 11B), a delta shape (FIG. 11C) or a trapezoidal shape (FIG. 11D), as in the first embodiment.

The fuel electrode layer 210 is formed on the outer surface of the single body support 200, and the electrolyte layer 220 is formed on the outer surface of the fuel electrode layer 210. The air electrode layer 230 is formed on the outer surface of the electrolyte layer 220. The fuel electrode layer 210, the electrolyte layer 220, and the air electrode layer 230 may be formed in the same manner as in the first embodiment.

As described hereinbefore, the present invention provides a fuel cell having a single body support. According to the present invention, an SOFC includes a single body support, and is thus more stably supported than when using a conventional ceramic support, thereby increasing durability and reliability.

According to the present invention, the single body support is manufactured through a single process unlike a conventional support, thus facilitating the formation of a stack and simplifying the connection of a current collector, resulting in simplified process and reduced manufacturing cost. Also, current collection resistance between unit cells is reduced, thus increasing performance of the fuel cell.

According to the present invention, the single body support is made of porous metal, thus eliminating a need for an additional current collector, and the current collection is possible thanks to the use of the single body support. The porous metal is more easily molded compared to ceramic, so that the fuel cell may be manufactured in a variety of shapes. Scaling up of the fuel cell is possible, and the fuel cell is hermetically sealed through welding upon bonding to a metal manifold, thus preventing gas from leaking.

Although the embodiments of the present invention regarding the fuel cell having the single body support have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A fuel cell, comprising:
a single body support, including a plurality of unit supports and a connector for connecting the plurality of unit supports in parallel;
an air electrode layer formed on an outer surface of the single body support;
an electrolyte layer formed on an outer surface of the air electrode layer; and
a fuel electrode layer formed on an outer surface of the electrolyte layer.

2. The fuel cell as set forth in claim 1, wherein the air electrode layer is formed only on an outer surface of the unit supports.

3. The fuel cell as set forth in claim 1, wherein the connector is formed to be shorter than the unit supports.

4. The fuel cell as set forth in claim 1, wherein the connector has a gas passage passing therethrough to be perpendicular thereto.

5. The fuel cell as set forth in claim 1, wherein each of the unit supports has a cross-section of a circular shape, a flat tubular shape, a delta shape or a trapezoidal shape.

6. The fuel cell as set forth in claim 1, wherein the single body support is made of a porous metal.

7. The fuel cell as set forth in claim 6, wherein the porous metal is selected from the group consisting of iron, copper, aluminum, nickel, chromium, alloys thereof and combinations thereof.

8. A fuel cell, comprising:
a single body support, including a plurality of unit supports and a connector for connecting the plurality of unit supports in parallel;
a fuel electrode layer formed on an outer surface of the single body support;
an electrolyte layer formed on an outer surface of the fuel electrode layer; and
an air electrode layer formed on an outer surface of the electrolyte layer.

9. The fuel cell as set forth in claim 8, wherein the fuel electrode layer is formed only on an outer surface of the unit supports.

10. The fuel cell as set forth in claim 8, wherein the connector is formed to be shorter than the unit supports.

11. The fuel cell as set forth in claim 8, wherein the connector has a gas passage passing therethrough to be perpendicular thereto.

12. The fuel cell as set forth in claim 8, wherein each of the unit supports has a cross-section of a circular shape, a flat tubular shape, a delta shape or a trapezoidal shape.

13. The fuel cell as set forth in claim 8, wherein the single body support is made of a porous metal.

14. The fuel cell as set forth in claim 13, wherein the porous metal is selected from the group consisting of iron, copper, aluminum, nickel, chromium, alloys thereof and combinations thereof.
